(19) United States
(12) Patent Application Publication
(10) Pub. No.: US 2021/0074254 A1
(43) Pub. Date: Mar. 11, 2021

(54) ICE BUCKET HAVING NOISE DAMPENING CHARACTERISTICS FOR USE IN A REFRIGERATOR

(71) Applicants: BSH Home Appliances Corporation, Irvine, CA (US); BSH Hausgeräte GmbH, Munich (DE)

(72) Inventors: Horst Drotleff, Aalen (DE); Marco Marques, Knoxville, TN (US)

(21) Appl. No.: 16/952,138

(22) Filed: Nov. 19, 2020

Related U.S. Application Data
(62) Division of application No. 15/727,654, filed on Oct. 9, 2017.

(51) Int. Cl. G10K 11/16; F25C 5/182

(52) U.S. Cl. CPC G10K 11/16; F25D 23/067; F25D 2300/00; F25C 5/182

(57) ABSTRACT

An ice bucket for storing ice pieces having noise dampening characteristics is provided for use in a refrigerator. For example, a noise dampening lining material is disposed on at least a portion of at least one the bottom wall or the side wall in the interior space of the ice bucket. Alternatively, at least a portion of at least one of the bottom wall or the side wall is reinforced with a honeycomb pattern, thereby to reduce vibration transmission and sound amplification. Still further, at least one grommet is disposed on an exterior portion of the bottom wall of the ice bucket so as to rest on a floor of the ice compartment region, thereby to reduce vibration transmission and sound amplification.

### CROSS-REFERENCE TO RELATED APPLICATION

The present application is a Divisional Application of U.S. patent application Ser. No. 15/727,654, filed Oct. 9, 2017, the contents of which are herein incorporated by reference in their entirety.

### FIELD OF THE INVENTION

The present disclosure relates generally to a refrigerator appliance and to an ice bucket for storing ice when ice is harvested from an ice maker. More particularly, the present disclosure relates to an ice bucket having noise dampening characteristics.

### BACKGROUND OF THE INVENTION

In general, domestic refrigerators include ice makers and ice buckets that are typically located in an ice compartment region of a freezer compartment or a fresh food compartment. When ice is made by the ice maker and harvested, the ice pieces drop or fall from the ice maker into the ice bucket and create a loud noise when the ice pieces hit the ice bucket. This loud noise can actually startle a homeowner due to the sudden loud sound of the ice pieces first hitting the ice bucket and, in some cases, can even be mistaken for someone trying to break into a home.

### SUMMARY OF THE INVENTION

However, the current ice buckets for refrigerators have no means for coping with the loud noise created when the ice pieces hit the ice bucket during ice harvest. For this reason, the current ice buckets are not well suited for use in luxury or higher end refrigerator models where the customer demands a much quieter operation of the refrigerator appliance overall.

An apparatus consistent with the present disclosure is directed to providing a more silent ice harvest process in a refrigerator appliance.

An apparatus consistent with the present disclosure is directed to an ice bucket for storing ice for use with an ice maker in a refrigerator and, more particularly, to an ice bucket having noise dampening characteristics.

According to one aspect, the present disclosure provides a refrigerator comprising: an ice compartment region disposed in at least one of a fresh food compartment or a freezer compartment; an ice maker disposed in the ice compartment region; and a removable ice bucket for storing ice, the removable ice bucket being removably disposed in the ice compartment region, wherein the removable ice bucket comprises means for dampening noise created by ice pieces falling from the ice maker during ice harvest and impacting the removable ice bucket.

According to another aspect, the ice compartment region is disposed in the freezer compartment.

According to another aspect, the ice compartment region is disposed in the fresh food compartment.

According to another aspect, the present disclosure provides an ice bucket for use with an ice maker in a refrigerator, the ice bucket comprising: a bottom wall and a side wall defining an interior space for storing ice pieces; and a noise dampening lining material disposed on at least a portion of at least one of the bottom wall or the side wall in the interior space.

According to another aspect, the noise dampening lining material is formed of silicone.

According to another aspect, the noise dampening lining material is formed of a food safe material.

According to another aspect, the noise dampening lining material is applied as a thin layer to an interior of at least one of the bottom wall or the side wall.

According to another aspect, the noise dampening lining material is disposed on an entire interior of the bottom wall.

According to another aspect, the noise dampening lining material is added to the interior space of the ice bucket as a separate piece that conforms to an internal shape of the ice bucket.

According to another aspect, the noise dampening lining material comprises a pattern of spacers on at least one surface thereof.

According to another aspect, the present disclosure provides an ice bucket for use with an ice maker in a refrigerator, the ice bucket comprising: a bottom wall and a side wall defining an interior space for storing ice pieces, wherein at least a portion of at least one of the bottom wall or the side wall is reinforced with at least one of an increased thickness or a rib-shaped pattern, thereby to reduce vibration transmission and sound amplification.

According to another aspect, the rib-shaped pattern comprises a honeycomb-shaped pattern.

According to another aspect, the honeycomb-shaped pattern is disposed at least one of internally or externally of the ice bucket.

According to another aspect, the present disclosure provides an ice bucket for use with an ice maker disposed in an ice compartment region of a refrigerator, the ice bucket comprising: a bottom wall and a side wall defining an interior space for storing ice pieces, wherein at least one grommet is disposed on an exterior portion of the bottom wall so as to rest on a floor of the ice compartment region, thereby to reduce vibration transmission and sound amplification.

According to another aspect, the at least one grommet comprises a plurality of grommets.

According to another aspect, the at least one grommet is pressed against the floor when the ice bucket is installed in position in the ice compartment region.

According to another aspect, the at least one grommet is formed of rubber.

According to another aspect, the ice compartment region is located in a fresh food compartment of the refrigerator.

According to another aspect, the ice compartment region is located in a freezer compartment of the refrigerator.

According to another aspect, the present disclosure provides an ice bucket for use with an ice maker in a refrigerator, the ice bucket comprising: a bottom wall and a side wall defining an interior space for storing ice pieces, wherein the ice bucket in its entirety is constructed of a sound and vibration absorbing material that is configured to withstand the weight of the ice pieces in a full ice bucket, as well as maintain a constant shape over time.

According to another aspect, the sound and vibration absorbing material comprises at least one of silicone, foam derivatives, rubber, elastomer or thermos-plastics.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a fragmentary perspective view showing the inside of a refrigerator appliance including an ice maker and an ice bucket in an ice compartment region located in a freezer compartment according to an exemplary embodiment consistent with present disclosure;

FIG. 2A illustrates a first embodiment of an ice bucket having noise dampening characteristics according to an exemplary embodiment consistent with present disclosure;

FIGS. 2B-2E illustrate an alternative of the first embodiment of an ice bucket having noise dampening characteristics according to an exemplary embodiment consistent with present disclosure;

FIG. 3 illustrates a second embodiment of an ice bucket having noise dampening characteristics according to an exemplary embodiment consistent with present disclosure;

FIG. 4 illustrates a third embodiment of an ice bucket having noise dampening characteristics according to an exemplary embodiment consistent with present disclosure; and

FIGS. 5A, 5B, and 5C show various views of an ice bucket having noise dampening characteristics for use with an ice compartment region located in a fresh food compartment according to an exemplary embodiment consistent with present disclosure.

### DETAILED DESCRIPTION OF THE EXEMPLARY EMBODIMENTS

The exemplary embodiments set forth below represent the necessary information to enable those skilled in the art to practice the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Moreover, it should be understood that terms such as top, bottom, front, rear, upper, lower, upward, downward, and the like used herein are for orientation purposes with respect to the drawings when describing the exemplary embodiments and should not limit the present invention. Further, terms such as right, left, right side, left side used herein are for orientation purposes with respect to the drawings when describing the exemplary embodiments and should not limit the present invention. Also, terms such as substantially, approximately, and about are intended to allow for variances to account for manufacturing tolerances, measurement tolerances, or variations from ideal values that would be accepted by those skilled in the art.

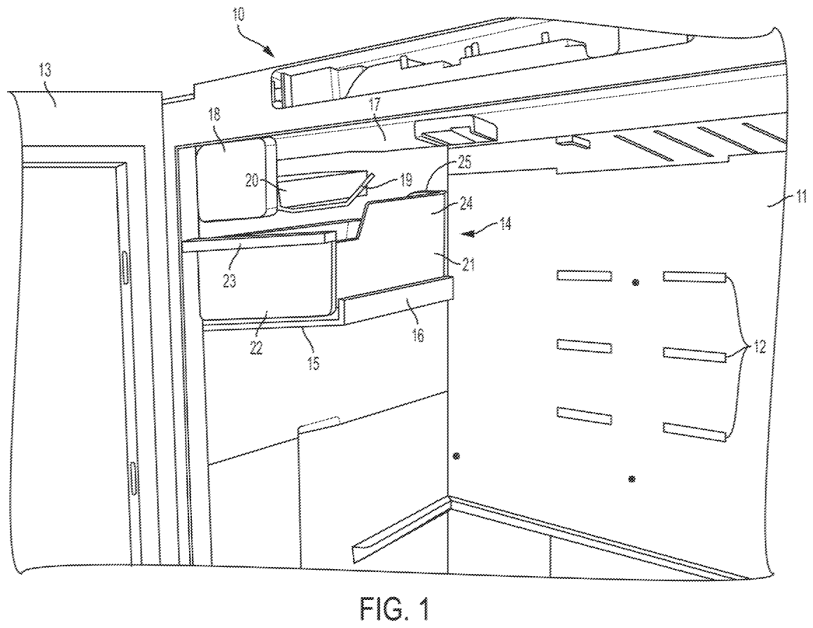

FIG. 1 is a fragmentary perspective view showing the inside of a refrigerator appliance including an ice maker and an ice bucket in an ice compartment region located in a freezer compartment according to an exemplary embodiment consistent with present disclosure. FIG. 1 shows a refrigerator appliance 10 and, in particular, the inside of a freezer compartment 11 having inlets 12 for introducing cold air, with the return air opening not being visible in the figure. At least one door 13 is mounted such as by hinges for providing access to and for closing the freezer compartment 11. In the upper left corner, for example, an ice compartment region 14 is provided and is at least partially defined by an L-shaped floor portion 15. Although the L-shaped floor portion 15 is shown with a short vertical side wall 16, the vertical side wall 16 can extend, for example, halfway or all the way to the ceiling 17 of the freezer compartment 11. An ice maker 18 having a bail arm 19 and an ice piece tray 20 is disposed in the uppermost left corner of the freezer compartment 11 in the ice compartment region 14. The ice maker 18 is configured to make ice in the form of ice pieces that may have various shapes such as cubed, elongated, curved, rounded, etc., as is conventional in the art.

An ice bucket 21 is provided underneath the ice maker 18. Although the term ice bucket is used, ice bin, ice storage container, and the like are alternative terms for describing the ice bucket 21. The ice bucket 21 is shown as a removable ice bucket for storing ice, the removable ice bucket being removably disposed in the ice compartment region 14. The ice bucket 21 has a front portion 22 with a grip 23 for a user to grasp with their fingers to pull and slide the ice bucket 21 out of the ice compartment region 14 to access the ice pieces or empty the ice pieces from the ice bucket 21. The ice bucket 21 rests on the L-shaped floor portion 15 when it is inserted into the ice compartment region 14. The ice bucket 21 may have a raised side wall portion 24 and raised rear wall portion 25 to help retain the ice pieces as they fall into the ice bucket 21 from the ice maker 18 during harvest and during storage as the level of the ice pieces increases in the ice bucket 21. The bail arm 19 is configured to turn the ice maker 18 on when the level of the ice pieces has gone below a preset level as the user removes the ice from the ice bucket 21 for use, as well as turn off the ice maker 18 when the ice pieces have reached a preset full level in the ice bucket 21.

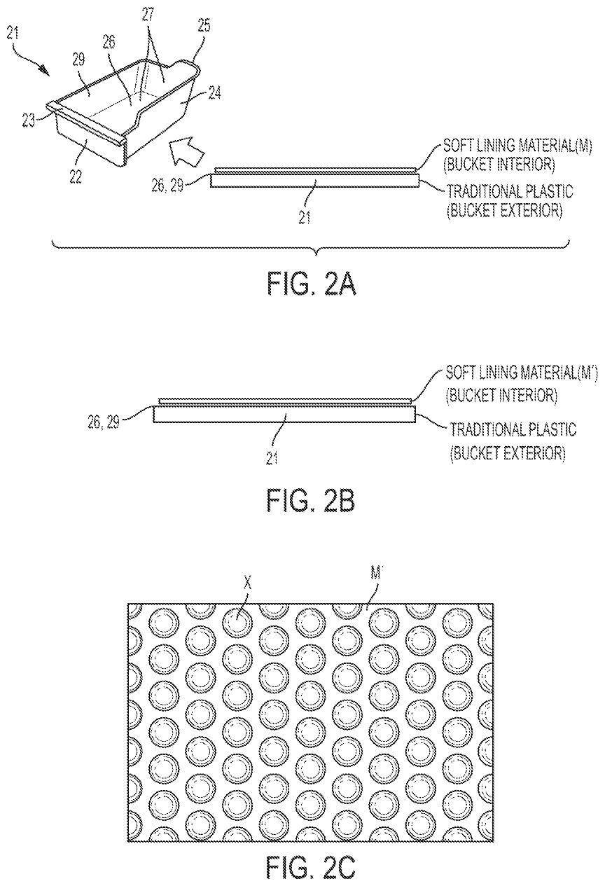

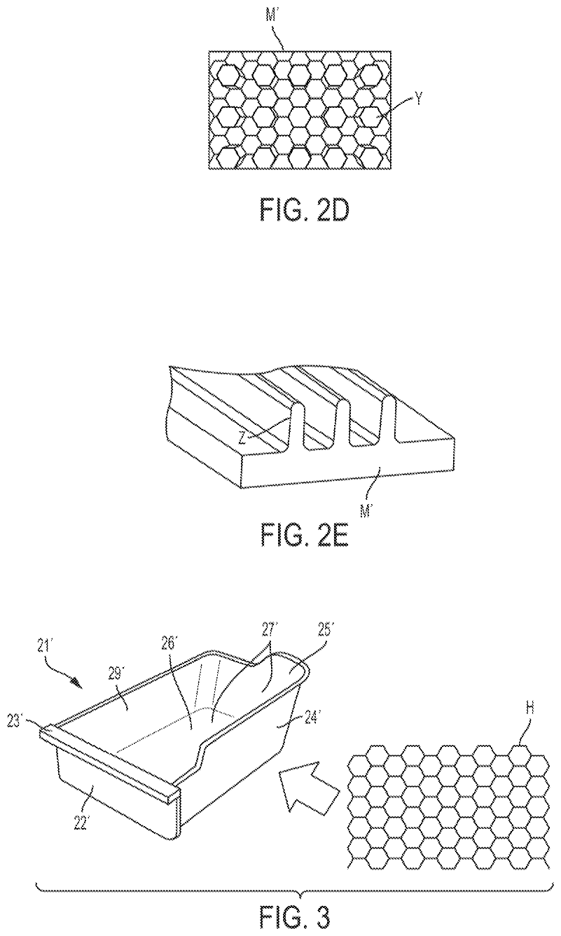

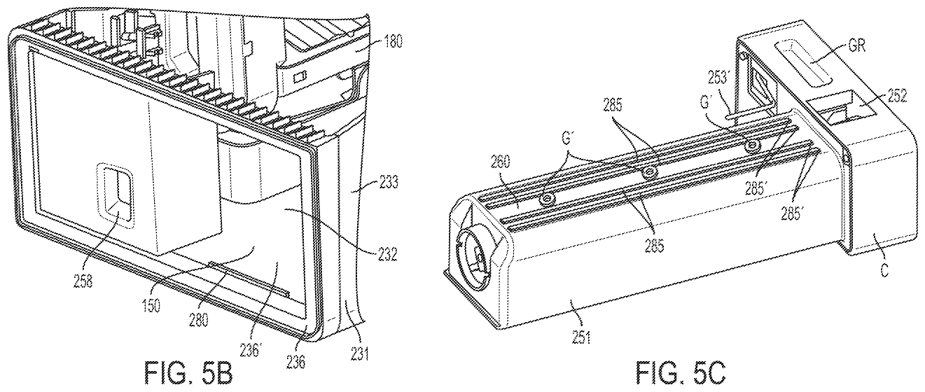

As shown in FIG. 1, because the ice bucket 21 is positioned below the ice maker 18 (or beside the ice maker 180 in the case of FIG. 5B), when ice pieces are made by the ice maker 18 and are dumped, for example, by a rotating ejector arm (not shown) that ejects the ice pieces from the ice piece tray 20 during harvest, the ice pieces fall and hit the ice bucket 21 with a certain velocity. In the conventional ice buckets, the impact of the ice pieces hitting the ice bucket causes a loud sound that can actually be amplified, especially as the ice pieces first hit the bottom of an empty ice bucket. This can cause a significant disturbance to the consumer/homeowner since such a loud, sudden noise can startle the consumer/homeowner, as it comes unexpectedly and may even give the impression that an intruder has broken into a dwelling. An apparatus consistent with the present disclosure is directed to an ice bucket 21 having noise dampening characteristics, as will be discussed in detail with reference to FIGS. 2A-5C.

FIG. 2A illustrates a first embodiment of the ice bucket 21 having noise dampening characteristics according to an exemplary embodiment consistent with present disclosure. In particular, the ice bucket 21 has means for dampening noise created by ice pieces falling from the ice maker during ice harvest and impacting the removable ice bucket. The means for dampening noise created by ice pieces falling from the ice maker during ice harvest and impacting the removable ice bucket may comprise a noise dampening lining material M disposed on at least a portion of the bottom wall 26 in the interior space 27 of the ice bucket 21. The noise dampening lining material M can be disposed on a portion of an interior of the bottom wall 26, the entire interior of the bottom wall 26, as well as a portion or the entire interior of the bottom wall 26 and a portion or an entire interior of the side walls 29 of the ice bucket 21. Preferably, but not necessarily, the noise dampening lining material M comprises a soft, food safe, easy to clean material that is configured to prevent or at least dampen the impact of the ice pieces as they hit the bottom wall 26 and/or the side walls 29 of the ice bucket 21, and also prevent or at least absorb vibration on the ice bucket 21 structure so as not to amplify any sound. Suitable materials for the noise dampening lining material M include, but are not limited to, silicone, foam derivatives, rubber, elastomer or thermoplastics. For example, the silicone can be applied as a thin layer to the interior of the bottom wall 26 and/or the side walls 29 of the ice bucket 21 by known manufacturing processes, such as co-injection, deposition and the like.

FIGS. 2B-2E illustrate an alternative of the first embodiment where different patterns of spacers can be used on the noise dampening lining material M′ applied to the internal side of the ice bucket 21 to further absorb the impact of the ice pieces. In particular, the spacers can take the form of, for example but not limited to, semi-spherical projections X, a honeycomb pattern Y (where one or more honeycomb units is raised above the others or all the honeycomb units are raised above the joining ribs), or a plurality of elongated plate-shaped ribs Z, where at least one of the spacers X, Y, or Z is located between the bottom wall 26 and/or the side walls 29 of the ice bucket 21 and the noise dampening lining material M′, or located on the internal, ice bucket-facing surface of the noise dampening lining material M′, or located on both the lower and upper surfaces of the noise dampening lining material M′, thereby providing some distance between the free end portions of the pattern of spacers and the noise dampening lining material M′ and also absorbing the impact and reducing transmitting of the impact to the ice bucket 21.

Alternatively, the noise dampening lining material M may be added to the interior space of the ice bucket 21 as a separate piece that conforms to an internal shape of the ice bucket 21. Still further, the entire ice bucket 21 may be constructed of a sound and vibration absorbing material such as, for example, silicone, foam derivatives, rubber, elastomer or thermoplastics that is also configured to withstand the weight of the ice pieces in a full ice bucket 21, as well as maintain a constant shape over time.

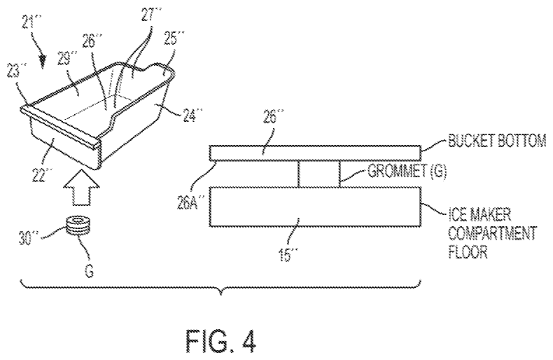

FIG. 3 illustrates a second embodiment of an ice bucket 21′ having noise dampening characteristics according to an exemplary embodiment consistent with present disclosure. Similar reference numbers are used to denote similar structure as in FIG. 2A, except that a prime sign (′) is added next to the reference numeral. In particular, the ice bucket 21′ has means for dampening noise created by ice pieces falling from the ice maker during ice harvest and impacting the removable ice bucket. The means for dampening noise created by ice pieces falling from the ice maker during ice harvest and impacting the removable ice bucket may comprise an ice bucket 21′ with increased structural rigidity or reinforcement in areas such as the bottom wall 26′ and/or the side walls 29′ of the ice bucket 21′ in order to avoid the vibration transmission and sound amplification when the ice pieces hit the ice bucket 21′. The increased structural rigidity or reinforcement may be achieved by injection molding the bucket shape of the ice bucket 21′ using increased plastic thickness and/or special rib-shaped patterns, such as a honeycomb-shaped pattern H, as shown in FIG. 3. The honeycomb-shaped pattern H can be disposed either internally or externally of the ice bucket 21′.

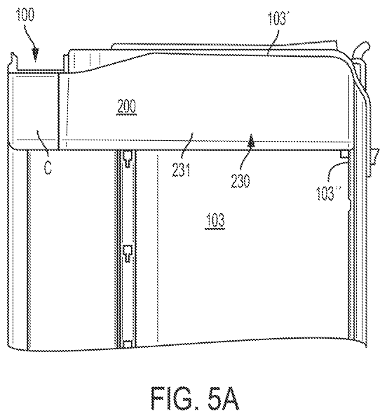

FIG. 4 illustrates a third embodiment of an ice bucket 21″ having noise dampening characteristics according to an exemplary embodiment consistent with present disclosure. Similar reference numbers are used to denote similar structure as in FIG. 2A, except that a double prime sign (″) is added next to the reference numeral. In particular, the ice bucket 21″ has means for dampening noise created by ice pieces falling from the ice maker during ice harvest and impacting the removable ice bucket. The means for dampening noise created by ice pieces falling from the ice maker during ice harvest and impacting the removable ice bucket may comprise an ice bucket 21″ with at least one grommet or pad G that is disposed on an exterior portion 26A″ of the bottom wall 26″ so as to rest on a floor 15″ of the ice compartment region, thereby to reduce vibration transmission and sound amplification.

In particular, as shown in FIG. 4, the grommet G is formed of a soft material such as, but not limited to, rubber (for example, Neoprene rubber). The rubber grommet G is, for example, fitted into a hole or recess in the exterior portion 26A″ of the bottom wall 26″ of the ice bucket 21″. When there is only one rubber grommet G, the rubber grommet G is preferably, but not necessarily, positioned at the geometrical center of the bottom wall 26″ (see FIG. 5C for an example of the positioning of multiple grommets). The rubber grommet G can have an annular recess 30″ formed therein so as to allow the upper portion of the grommet G to be fitted into the hole or recess in the exterior portion 26A″ of the bottom wall 26″ of the ice bucket 21″ and to engage with an annular lip in the opening or recess. Alternatively, the rubber grommet G can be adhered to the bottom wall 26″ of the ice bucket 21″ by a suitable adhesive. Preferably, the rubber grommet G is slightly compressed or pressed against the floor 15″ when the ice bucket 21″ is installed in position in the ice compartment region 14, thereby increasing the rigidity of the bottom wall 26″ of the ice bucket 21″ to reduce the amplification of the sound when the ice pieces impact the ice bucket 21″ during ice harvest.

Of course, the ice bucket (21, 21′, 21″) may include combinations of two or more of the embodiments described above with respect to FIGS. 2A-4 of the means for dampening noise created by ice pieces falling from the ice maker during ice harvest and impacting the removable ice bucket.

FIGS. 5A, 5B, and 5C show various views of an ice bucket having noise dampening characteristics for use with an ice compartment region 200 located in a fresh food compartment 103 of a refrigerator 100 according to an exemplary embodiment consistent with present disclosure.

As best shown in FIGS. 5A and 5B, an ice compartment housing assembly 230 may be formed by, for example, a U-shaped or an L-shaped insulated housing 231 that cooperates with the inner top wall 103′ and the inner back wall 103″ (and the inner side wall in the case of an L-shaped insulated housing) of the fresh food compartment 103. As best shown in FIG. 5A, the insulated housing 231 is contoured to fit the shape of the inner top wall 103′ and an inner back wall 103″ of the fresh food compartment 103. The insulated housing 231 includes insulation (not shown) (formed of, for example, expanded polypropylene (EPP), expanded polystyrene (EPS), vacuum insolated panel (VIP)), disposed between an inner wall 232 and an outer wall 233, a gasket (not shown) that is disposed between an edge of the insulated housing 231 and the inner top wall 103′ and the inner back wall 103″ of the fresh food compartment 103, and a housing collar 236 (see FIG. 5B) that is disposed on an open front portion of the insulated housing 231, the housing collar 236 having an opening 236′ therein for receiving an ice bucket 251 (see FIG. 5C). As shown in FIG. 5B, an ice maker 180 is disposed next to the ice bucket 251 within the insulated housing 231.

As shown in FIGS. 5A and 5C, the ice bucket 251 having a front cover C is removably mounted in the insulated housing 231 of ice compartment housing assembly 230. The front cover C has the ice bucket outlet opening 252 on the bottom through which ice pieces are delivered when a user dispenses ice pieces. The ice bucket outlet opening 252 cooperates with the ice chute extension (not shown) to deliver ice pieces to a dispenser (not shown) when the door to the fresh food compartment is in a closed position.

FIG. 5B shows a retention rib 280 projecting upward from the lower surface of the housing collar 236 and into the opening 236′ and configured to engage with the front end portions 285′ of a plurality of ribs or rails 285 formed on the bottom surface 260 of the ice bucket 251 (see FIG. 5C) to retain the ice bucket 251 within the insulated housing 231 on condition that the ice bucket 251 is fully inserted into insulated housing 231 of the ice compartment housing assembly 230 in the ice compartment region 200. The ribs 285 also facilitate the sliding action of the ice bucket 251 when it is removed by a user or returned back into position within the ice compartment housing assembly 230. The bottom of the front cover C also includes a gripper recess GR for the user to insert their fingers to pull and remove the ice bucket 251 or return the same into position. The user would simply lift and pull back the front cover C using the gripper recess GR to slide the ribs 285 (and grommets discussed below) of the ice bucket 251 up and over the retention rib 280.

As shown in FIGS. 5B and 5C, a rod 253′ passes through an opening 258 in the housing collar 236 and is configured to actuate a gate member (not shown) in the front cover C for delivering either crushed ice or whole pieces of ice such as cubed ice.

The ice bucket 251 may include any of the means for dampening noise created by ice pieces falling from the ice maker during ice harvest and impacting the removable ice bucket described above with respect to FIGS. 2A-4 including combinations of two or more of the embodiments described above. For example, as shown in FIG. 5C, the bottom surface 260 of the ice bucket 251 may include one or more grommets or pads G′. For example, one or more (for example, three are shown in FIG. 5C) rubber grommets G′ are disposed on the bottom surface 260 at equally spaced intervals between the two pairs of ribs 285. The rubber grommets G′ project slightly above the ribs 285. The rubber grommets G′ are then slightly compressed or pressed against the floor 150 when the ice bucket 251 is fully inserted into the insulated housing 231 of the ice compartment region 200, thereby increasing the rigidity of the bottom wall 260 of the ice bucket 251 to reduce the amplification of the sound when the ice pieces impact the ice bucket 251 during ice harvest. The ice bucket 251 can also employ the noise dampening lining material M described above with respect to FIGS. 2A and 2E, the increased plastic thickness and/or special rib-shaped patterns, such as a honeycomb-shaped pattern H, as shown in FIG. 3, instead of or together with the one or more grommets G′.

The present invention has substantial opportunity for variation without departing from the spirit or scope of the present invention. For example, while the embodiments above have been described with respect to a removable ice bucket (21, 21′, 21″, 251), the ice bucket may be fixed in place in an ice compartment region within the freezer compartment or fresh food compartment. The fixed-in-place ice bucket may include at least one, as well as combinations of two or more of the embodiments described above with respect to FIGS. 2A-5C of the means for dampening noise created by ice pieces falling from the ice maker during ice harvest and impacting the removable ice bucket.

Those skilled in the art will recognize improvements and modifications to the exemplary embodiments of the present invention. All such improvements and modifications are considered within the scope of the concepts disclosed herein and the claims that follow.

What is claimed is:

1. An ice bucket for use with an ice maker disposed in an ice compartment region of a refrigerator, the ice bucket comprising:
a bottom wall and a side wall defining an interior space for storing ice pieces,
wherein at least one grommet is disposed on an exterior portion of the bottom wall so as to rest on a floor of the ice compartment region, thereby to reduce vibration transmission and sound amplification.

2. The ice bucket of claim 1, wherein the at least one grommet comprises a plurality of grommets.

3. The ice bucket of claim 1, wherein the at least one grommet is pressed against the floor when the ice bucket is installed in position in the ice compartment region.

4. The ice bucket of claim 1, wherein the at least one grommet is formed of rubber.

5. The ice bucket of claim 1, wherein the ice compartment region is located in a fresh food compartment of the refrigerator.

6. The ice bucket of claim 1, wherein the ice compartment region is located in a freezer compartment of the refrigerator.

7. An ice bucket for use with an ice maker in a refrigerator, the ice bucket comprising:
a bottom wall and a side wall defining an interior space for storing ice pieces; and
a noise dampening lining material disposed on at least a portion of at least one of the bottom wall or the side wall in the interior space.

8. The ice bucket of claim 7, wherein the noise dampening lining material is formed of silicone.

9. The ice bucket of claim 7, wherein the noise dampening lining material is formed of a food safe material.

10. The ice bucket of claim 7, wherein the noise dampening lining material is applied as a thin layer to an interior of at least one of the bottom wall or the side wall.

11. The ice bucket of claim 7, wherein the noise dampening lining material is disposed on an entire interior of the bottom wall.

12. The ice bucket of claim 7, wherein the noise dampening lining material is added to the interior space of the ice bucket as a separate piece that conforms to an internal shape of the ice bucket.

13. The ice bucket of claim 7, wherein the noise dampening lining material comprises a pattern of spacers on at least one surface thereof.

14. An ice bucket for use with an ice maker in a refrigerator, the ice bucket comprising:
a bottom wall and a side wall defining an interior space for storing ice pieces,
wherein at least a portion of at least one of the bottom wall or the side wall is reinforced with at least one of an increased thickness or a rib-shaped pattern, thereby to reduce vibration transmission and sound amplification.

15. The ice bucket of claim 14, wherein the rib-shaped pattern comprises a honeycomb-shaped pattern.

16. The ice bucket of claim 15, wherein the honeycomb-shaped pattern is disposed at least one of internally or externally of the ice bucket.

17. An ice bucket for use with an ice maker in a refrigerator, the ice bucket comprising:
a bottom wall and a side wall defining an interior space for storing ice pieces, wherein the ice bucket in its entirety is constructed of a sound and vibration absorbing material that is configured to withstand the weight of the ice pieces in a full ice bucket, as well as maintain a constant shape over time.

18. The ice bucket of claim 17, wherein the sound and vibration absorbing material comprises at least one of silicone, foam derivatives, rubber, elastomer or thermoplastics.
